(19) United States
(12) Patent Application Publication
(10) Pub. No.: US 2018/0307741 A1
(43) Pub. Date: Oct. 25, 2018

(54) FILTERING TRAINING DATA FOR SIMPLER RBF MODELS

(71) Applicant: Intel Corporation, Santa Clara, CA (US)

(72) Inventor: Luis Sergio Kida, Beaverton, OR (US)

(21) Appl. No.: 15/496,540

(22) Filed: Apr. 25, 2017

(51) Int. Cl. G06F 17/30; G06N 99/00

(52) U.S. Cl. CPC G06F 17/30598; G06N 99/005

(57) ABSTRACT

Methods and apparatus are described by which a reduced training data set is created from an initial training data set. Examples within the initial training data set are classified into various classes, such as noise and boundary classes, based upon other examples within the vicinity of the example. Examples are then filtered from the initial training data set based upon the classification and properties of the examples within the vicinity of an example. The filtered training data set is used to create a classifier model. The classifier models are less complex and require less computation resources compared to a model created with the entire initial training data set.

### TECHNICAL FIELD

Embodiments described herein relate generally to machine learning, specifically to reducing a training set used to build a classifier without loss of information and/or accuracy.

### BACKGROUND

With the growth of the Internet of Things (IoT) computation has been moving from the data center to “the edge” to be closer to where the environment is sensed. Some IoT devices attempt to reduce communication bandwidth and to reduce the latency between sensing an event and reacting to the event. Concurrently, machine learning has been growing in importance and popularity because it allows finding hidden insights without explicitly programming the solution.

The combination of both trends towards developing embedded applications with machine learning is limited by IoT devices with little memory and low computation performance compared to computing resources available in data centers and cloud providers. The problem with low computation performance and memory resources of IoT devices is amplified with machine learning algorithms that optimize for correctness without regard for computation demand and memory footprint.

### BRIEF DESCRIPTION OF THE DRAWINGS

FIG. 1 is a block diagram for training a model.

FIG. 2 illustrates a training data of three classes set plotted in two-dimensional space in accordance with some examples.

FIG. 3 illustrates training data with classes and an uncertainty area in accordance with some examples.

FIG. 4 illustrates training data with some labeled examples in accordance with some examples.

FIGS. 5A-5G illustrate results of various different vector separations in accordance with some examples.

FIGS. 6A and 6B illustrate filtering samples based on a core ratio in accordance with some examples.

FIGS. 7A-7C illustrate different training data sets based upon various core ratio values in accordance with some examples.

FIG. 8 illustrates results of various different models using different training data sets in accordance with some examples.

FIG. 9 is a flow diagram for filtering training data in accordance with some examples.

FIG. 10 is an example computing device that may be used in conjunction with the technologies described herein.

### DETAILED DESCRIPTION

Reducing the complexity of a classifier model, e.g., a model, a classifier, or a learned classifier, may reduce the memory and computing resources to use the operational classifier. The complexity of the model may be reduced by selectively removing samples from the training data used to create the model. In addition, the samples that are removed or filtered may be selected to minimize any loss in sensitivity or accuracy relative to the model created with the complete set of training data. Sensitivity and accuracy are two ways to estimate the performance of a model. Accuracy measures how many samples a model correctly classifies. Accordingly, a model that classifies 90 out of 100 samples correctly will have a 90% accuracy. Accuracy, however, does not take into account how the model classifies different classes. Sensitivity measures for each class how many of the samples of each class are correctly identified. Continuing the same example, if the model is tested with 30 samples of class 1; 30 samples of class 2; and 40 samples of class 3, sensitivity measures how many of the samples of each class were classified to the correct class. Sensitivity, therefore, is measured on a per class basis. For this example, if the 30 samples of class 1 were all correctly classified; 30 samples of class 2 were all correctly classified; and 30 samples of class 3 were correctly classified the sensitivity would be 100% for class 1 and class 2 and 75% for class 3. The average sensitivity of one or more classes may be used to gauge the performance of a model. In an example, the average sensitivity over all classes is used to measure the performance of a model. Using the average sensitivity of the three class in the above example, the average sensitivity would be ˜92%. In the discussion below, a model may be ranked or validated based upon either or both the accuracy or average sensitivity of the model.

Training samples in training data contribute differently to the building of the model. Some samples add complexity with little improvement to the accuracy of the model. In addition, some samples may cause a more complex model to have lower accuracy. Identifying some or all of the samples that add complexity to the model or cause a reduction in accuracy is useful to determine which samples may be filtered from the training data. Once these samples are removed, the filtered training data may be used to create a model. This model may be less complex compared to a model created with the entire training data. A less complex model generally requires less memory and less computation power to create and operate compared to the model trained on the full training data set.

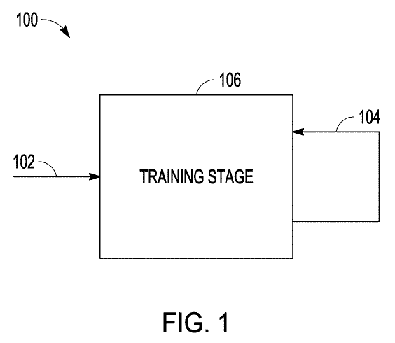

FIG. 1 is a block diagram 100 for training a model. A body of data may be used to train and validate a classifier or model. The data includes numerous samples, each sample includes various properties of an item that may be classified into one of many classes. The various properties may be in the form a vector of values, which each value representing a property of the item. As an example, the data set may include samples that are either a house or of a boat. Each sample may contain various properties of the item that are used to classify the item as a boat or a house. A subset of the data may be used as training data used to train a model to classify a sample. The training data is labeled, meaning each sample in the training data includes the sample's correct class. Another subset of the data may be used to validate a learned model. The verification data is also labeled with each sample's known class, which is used to determine if the learned model correctly classified a sample within the verification data set.

Machine learning uses training data to create model used to classify data outside of the training data. In FIG. 1, training data 102 is input into a model 106. The model 106 is created based upon the training data 102. In an example, the model 106 uses radial basis functions (RBF) to classify a sample based upon the sample's properties. The model 106 may be adjusted by adding or removing radial basis functions and/or changing a property of one or more of the radial basis functions to gain better accuracy. For example, an RBF may be added or removed, or parameters of the RBF functions 104 can be changed or modified by the training data 102 fed into the modified model. The result of the adjustment may be measured based upon the results of the modified model compared to the accuracy of the change with previous versions of the model.

Training or learning a classifier model, e.g., an RBF classifier, attempts to most accurately classify the training samples correctly. This, however, may lead to overlearning the training data and may also lead to more complex models that attempt to model various edge cases within the training data. In an example, the complexity of the RBF classifier model may be reduced by finding a smaller number of RBFs that cover the samples in the reduced or filtered training data with the correct class compared to the number of RBFs when trained with the full training data. While the absolute minimum number of RBFs needed to cover the training data may not be known, reducing the number of RBFs in a model results in a less complex model that uses less memory and computational resources to operate.

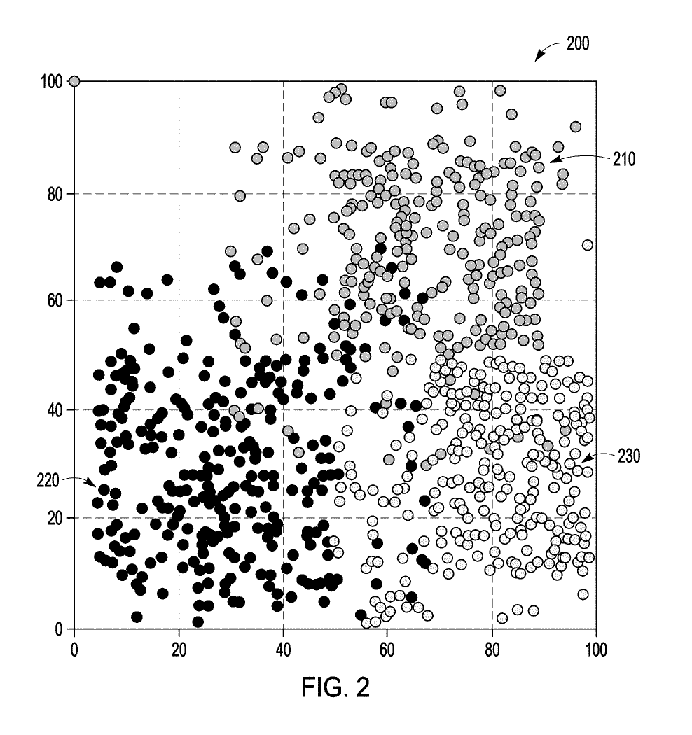

The amount of training data impacts the complexity of the trained model as well as the computational resources consumed to train and operate the model over unclassified samples. Each element in the training data may also impact the model by making the model less accurate. FIG. 2 illustrates training data of three classes set plotted in two-dimensional space in accordance with some examples. There are three classes 210, 220, and 230 represented by the training data. Each class 210, 220, and 230 has a core section where the majority of samples in an area all belong to only one of the three classes 210, 220, and 230.

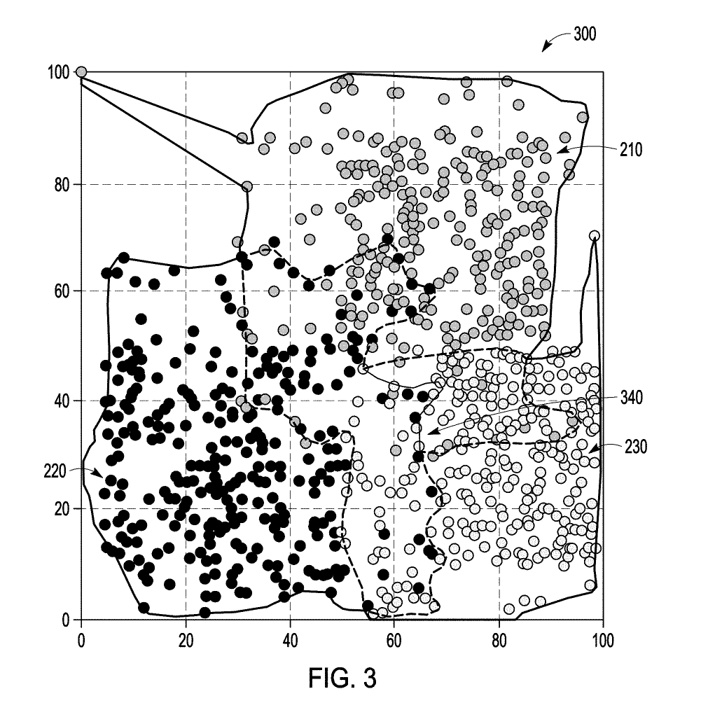

There are areas, however, where samples from different classes are intermixed. FIG. 3 illustrates training data with classes 210, 220, and 230 and an uncertainty area in accordance with some examples. The same three classes 210, 220, and 230 are shown along with an ambiguous area 340 where a classifier will have to distinguish between samples with similar properties but belonging to different classes. One example of samples that may be removed from the training data are samples within the ambiguous areas. Other examples, include samples of one class that are far away from any core area of the same class.

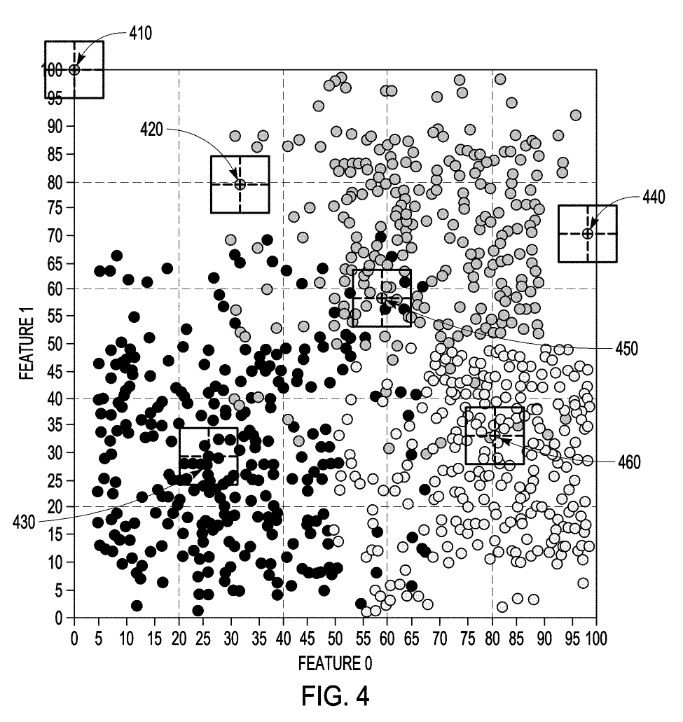

FIG. 4 illustrates some of these different types of samples with some samples labeled in accordance with some examples. The same training data from FIGS. 2 and 3 are shown in FIG. 4. To classify a sample, other samples within a particular vicinity, e.g., an immediate vicinity, of the sample are determined and analyzed. In an example, the immediate vicinity may be a radius of a radial basis function (RBF) centered on a particular sample. Based upon both the number of samples and the classes of these samples within the vicinity of a sample, each sample may be classified. The classification of the samples in this analysis describes how each potential training element relates to other samples near that training element. Therefore, the classification gives an indication of the usefulness of an RBF centered on the sample. Using samples within the immediate vicinity differentiates this classification from nearest neighbor type classification algorithms.

In an example, each element may be classified as an edge element, a noise element, a core element, or a boundary element. In another example, an outlier isolated element may also be classified. As noted above, the classification of one sample is based upon the other samples within the vicinity of the one sample. In FIG. 4, the vicinity of various samples is shown as a square surrounding the sample. The vicinity may also be referred to as a frame of the sample. In an example, the classifier for classifying training data elements may have two parameters: few and many. These parameters are used to classify the samples within the training data.

The various types of examples are illustrated in FIG. 4. One class is a core sample 430. A core sample 430 is a sample that has more than the many parameter of samples of the same class as the core element in its vicinity and less than the few parameter of samples of different classes as the core element in its vicinity. In other words, within the sample's frame there are more than many samples of the same class and less than few samples of different classes. Core samples provide a region where unseen samples in the region are classified the same as the core samples.

Another class is a noise class 460. A sample that is classified as noise is one that likely negatively impacts the accuracy of the model and/or creates a more complex model. A sample may be classified as noise if within the sample's frame there are less than few samples of the same class but there are more than many samples of different classes.

A noise sample may be viewed as isolated from other samples of the same class. An RBF learned at the center of the noise sample will contribute few additional correct classifications of unseen test samples of the same class as the noise sample. Noise samples may lead to more complex models because learning an RBF centered on a noise sample adds a pattern with a very small radius to avoid other samples of different classes. The very small radius may lead to the model over fitting the training data. Conversely, if the radius of the RBF is larger, the RBF will cover other samples of different classes leading the model to incorrectly classify these other samples with the class of the noise sample. Thus, lowering the accuracy of the model. In an example, samples classified as noise may be filtered from the training data set. This allows learning an RBF with a larger radius to cover the other classes within the filtered sample's vicinity which leads to a simpler model. Further, the simpler model may even have a gain in accuracy since the RBF that would cover the noise element may have a radius large enough to incorrectly cover other elements.

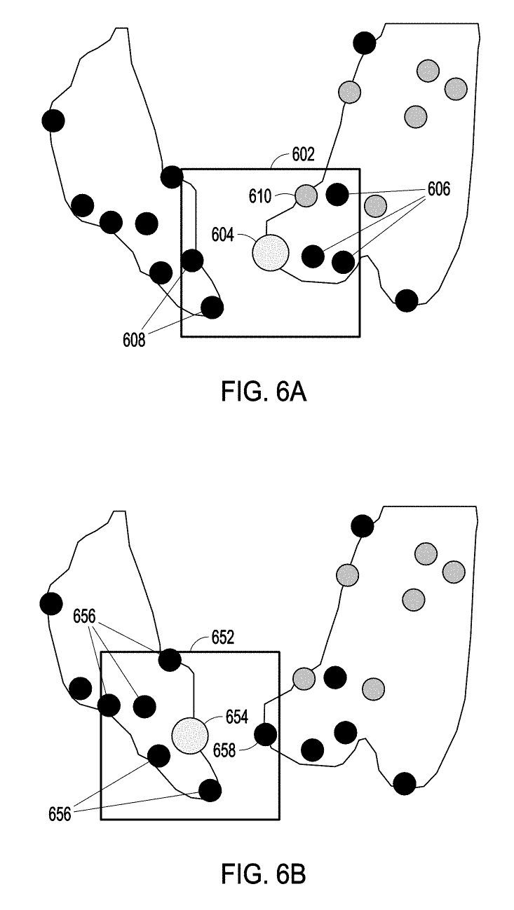

A third class of samples is a boundary class 450. A boundary class 450 may look similar to noise, but there is a more comparable distribution of the samples between the class of the sample and all the other classes. In an example, a training data sample is classified as a boundary sample when within the frame of the sample there are more than few samples of the same class and more than few samples of different classes. This is an area of confusion or ambiguity within the training data. A model may add one or more RBFs to regions that include lots of boundary samples. These RBFs are likely to cover samples belonging to two or more different classes. In an example, some or all of the boundary samples may be removed from the training data. In another example, boundary samples may be filtered by favoring one class. For example, the class with the most elements within the element's vicinity may be the favored class. In another example, the closest core sample is determined and the class of the closest core sample is the favored class. In this example, if the boundary sample belongs to the favored class the boundary sample is not filtered from the training data. In another example, the region is assigned to the class with the highest cost of a false negative classification by filtering out the samples of other classes. For example, the class of negative for cancer detection is filtered out, leaving only the samples of positive cancer detection. Using a boundary ratio, as described in greater detail below in regard to FIGS. 6A and 6B, may also be used to filter boundary samples. Filtering boundary samples may lead to an RBF covering samples from different classes. The loss of accuracy, however, is likely to be small given that the boundary region is one of confusion and has samples covering different classes.

An edge class 440 is another way to classify a sample. A sample is considered an edge when within the sample's frame there are few samples of the same class and few samples of different classes. A second edge class 420 is illustrated in FIG. 4. An outlier isolated sample 410 is a more refined edge classification. In an example, an outlier isolated sample is where within the frame of the sample there are few samples of the same class and no samples of different classes. In another example, an outlier isolated sample is where within the frame of the sample there are no samples of the same class and no samples of different classes. In other words, the difference between an edge and an outlier isolated is the distance from the sample to a core or cluster of the class. Edge samples may lead to more complex models because the learning of that sample adds a pattern, e.g., a RBF, to cover very few samples. In an example, the edge samples may be filtered from the training data. In another example, the outlier isolated samples are filtered and some or all of the edge samples are filtered from the training data. The ability to identify edge and outlier samples is a differentiation from the nearest neighbor classification algorithms that ignore the information of vicinity and will find the same number of nearest neighbors regardless of the distance from the sample.

Table 1 below summarizes rules that may be used to classify training data samples. The number of samples within the vicinity of a sample is determined and the class of each sample is determined. Based upon these values, the classification of a sample may be determined.

| Classification | # of Same Class | # of Different Class |
|---|---|---|
| Outlier/Edge | <FEW | <FEW |
| Noise | <FEW | >MANY |
| Core | >MANY | >MANY |
| Boundary | >FEW | >FEW |

After classifying the samples in the training data, various samples may be filtered from the training data using the classification of the samples. For example, all noise and outlier isolated samples may be removed to create the training data used to train a model. In another example, after the noise and outlier isolated samples are removed some or all boundary samples are removed. For example, boundary samples may be filtered such that a particular class is favored in a boundary region. In an example, the distance to the closest core sample for all classes may be determined. If the sample matches the class of the closest core sample, the boundary sample is retained. If the sample does not match the class of the closest core sample, the boundary sample may be filtered from the training data. In another example, boundary samples may be filtered using a core ratio which is explained in great detail below in regard to FIGS. 6A and 6B.

In an example, the various ways samples may be filtered are summarized as follows. Most or all samples that are classified as noise may be removed from the training data set. This may lead to models with a reduced number of RBFs and allow for larger radii of the RBFs within the model. Some or all of the outlier and edge samples may be filtered. This may lead to models with a reduced number of RBFs needed to model all of the training data to the desired quality. In an example, some or all of the boundary samples may be filtered to reduce the number of RBFs in the trained model. In addition, the RBFs within the model may allow for larger radii of the RBFs in the boundary regions and/or adjacent core regions. These various ways of filtering samples may be combined together. For example, the noise and boundary samples may be filtered or the noise, edge, and boundary samples may all be filtered to create a new training data set.

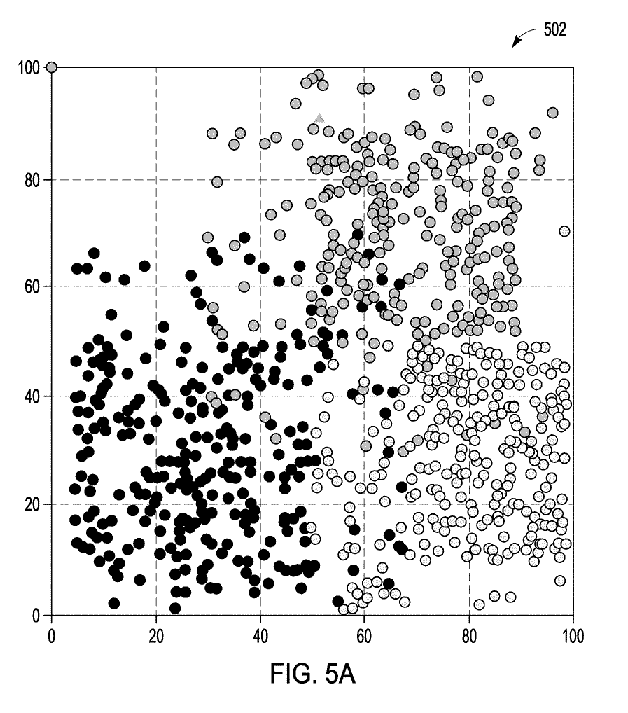

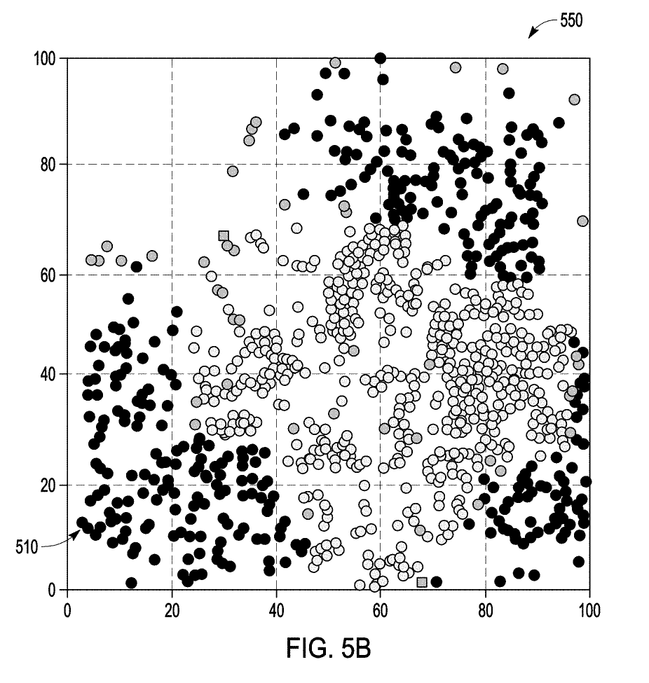

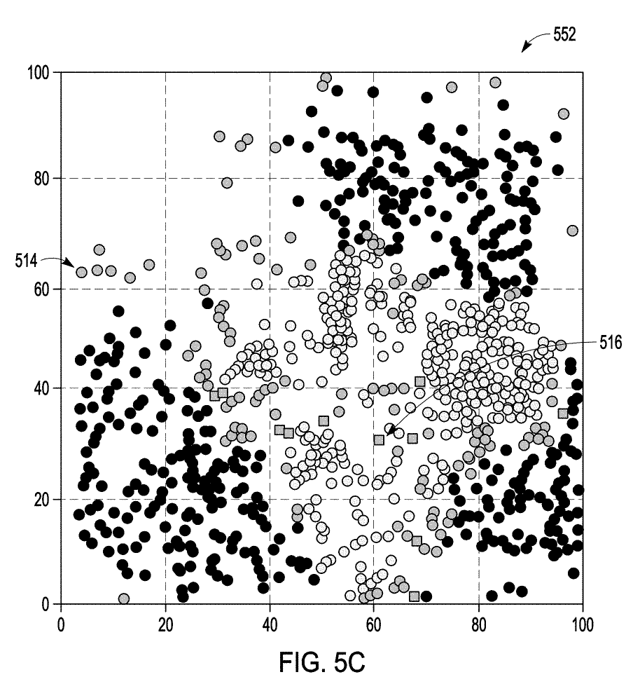

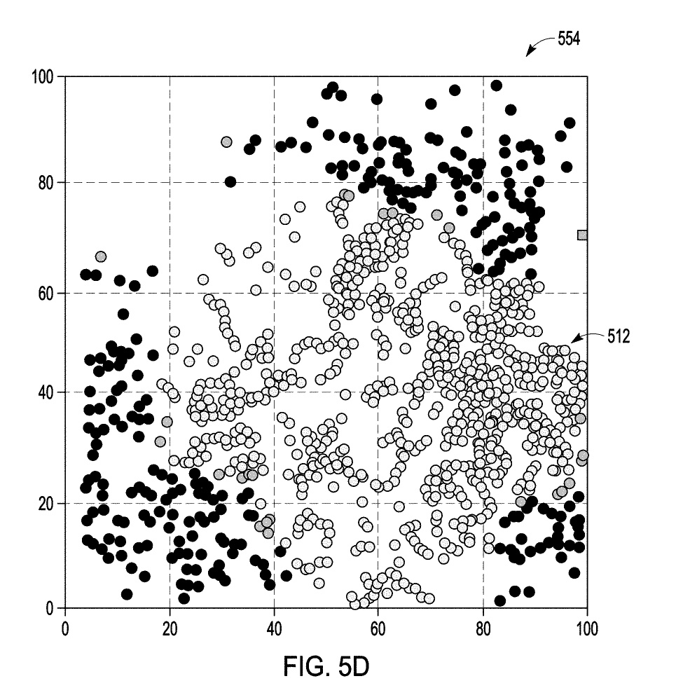

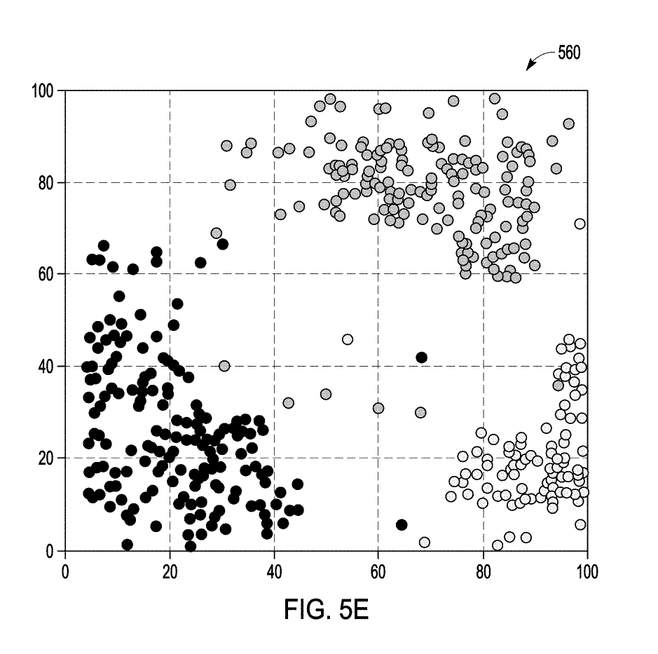

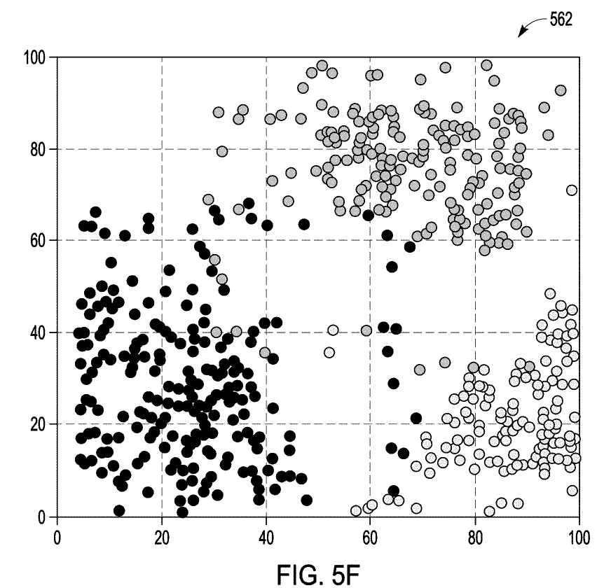

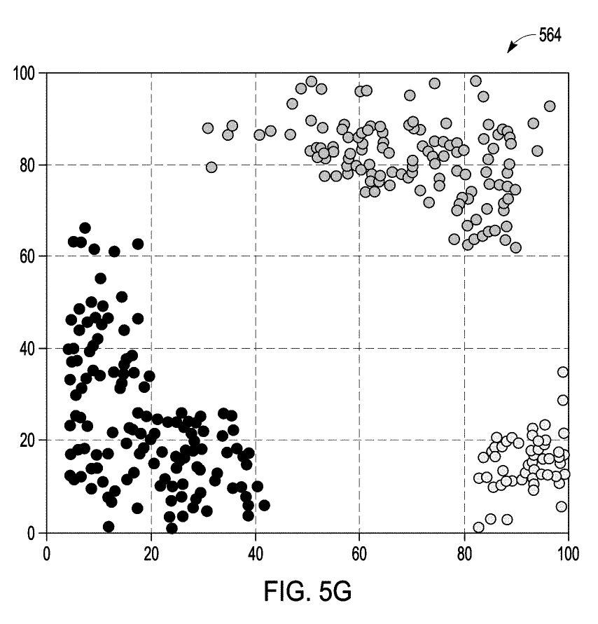

The reduction in the training data set may be seen in FIGS. 5A-5G. FIG. 5A illustrate the full training set of samples 502. As described above, from the full set of samples various different training data sets can be generated. FIGS. 5B-5D illustrate how samples are classified based upon different parameters. Samples in these graphs are classified as one of a core class 510, a border/boundary class 512, an edge class 514, or a noise class 516. The differences between the graphs in FIGS. 5B-5D are due to different parameters used to classify the samples. For example, the size of the frame and the many/few parameters are changed for each graph. The many/few parameters are used to classify a sample. For example, table 1 indicates how the many/few parameters may be used to classify a sample. Graphs 550 and 552 have the same frame size that is smaller than the frame size used in classifying the samples shown in graph 554. The many/few parameters are the same for graphs 550 and 554 and smaller than the many/few parameters used to classify the samples illustrated in graph 552.

Once the samples are classified, certain samples may be filtered out. The filtered training sets are illustrated in FIGS. 5E-5G. FIGS. 5B-5D correspond to FIGS. 5E-5G, respectively. In the illustrated examples, the boundary and noise samples are all filtered. The edge and core classes are not filtered. The differences in the classification of samples is shown by comparing FIGS. 5E-5G. FIG. 5G and the corresponding sample classification shown FIG. 5D has smaller clusters of core samples that leads to a training set with more defined classification boundaries compared with FIGS. 5E and 5F. Each of the training sets, from FIGS. 5E-5G, may be used to build models. Validation data sets may then be used to determine the accuracy and/or sensitivity of the different models.

In an example, the edge classes may be completely filtered out. In another example, edge classes may or may not be filtered. For example, a sample that is classified into the edge class may be filtered if the closest core sample has the same class as the edge sample. In this example, the edge sample will not be filtered if the edge sample is closest to a core sample where both samples should be classified into the same class by the trained model. Filtering out edge classes where the closest core sample is in a different class results in a simpler model since a larger RBF may be learned to cover the core class without the filtered edge class of different classification interfering with learning the RBF. The resulting RBF may incorrectly classify the filtered edge class, however, given that the sample is an edge class the loss of accuracy should be small.

The training data shown in the graphs in FIGS. 5E-5G is the resulting training data after the various examples are classified and filtered. The training data in FIGS. 5E-5G may be used instead of the entire training data from FIG. 5A. The three different filtered sets may be used to create three different classifying models. As described in greater detail below, verification data may be used to determine which of the three resulting models has the highest accuracy of correctly classifying the verification data. The parameters of the classifying and filtering may be changed until a certain accuracy of the validation data is reached. Further, each of the three resulting models should be less complex and take less time to train compared to the model trained using the full training data from FIG. 5A.

As noted above, in an example a training sample that is classified as a border class may or may not be filtered. In one example, the border class sample may be filtered based upon a core ratio. FIGS. 6A and 6B illustrate filtering samples based on a core ratio in accordance with some examples. In an example, the core ratio is calculated as the number of core samples of the same class as a border sample divided by the total number of samples in the border sample's frame. The core ratio may be seen as a measure of how many core elements are in the element's vicinity compared to other border elements. In other words, the core ratio is an estimate of how close a border element is to core elements of the same class.

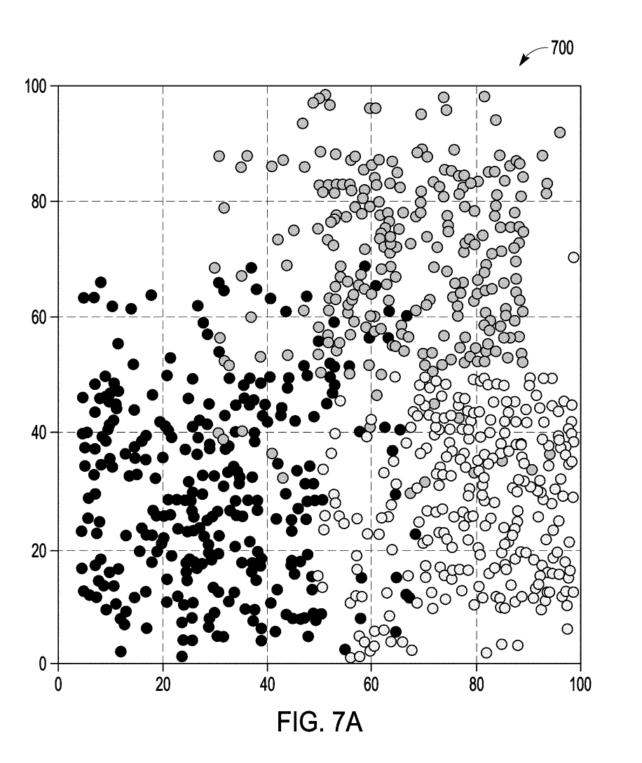

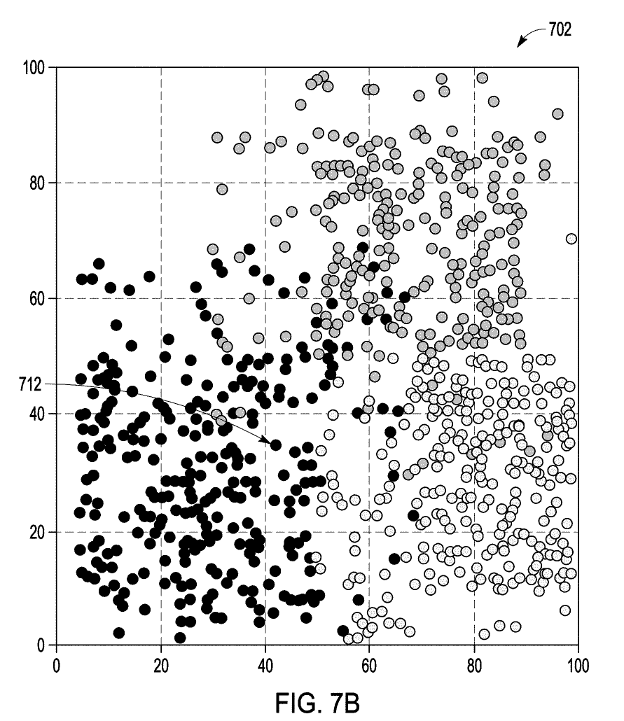

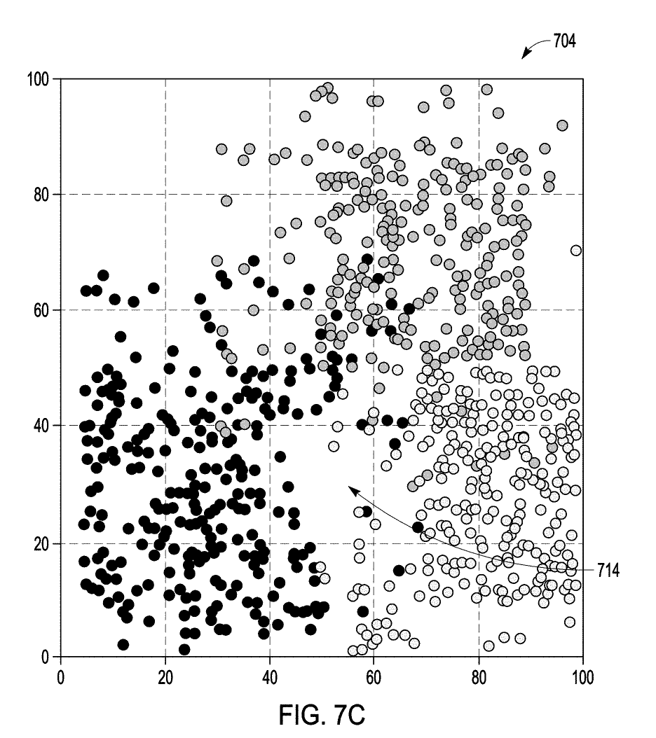

In the frame 602, the core ratio is 3/6 compared to a core ratio of 5/6 as shown in frame 652. In frame 602, there are three samples of the same class 606 as the border sample 604; two core samples from a different class 608; and another border sample 610. In frame 652, there are five core samples of the same class 656 of the border element 654 and one core sample of a different class 658. The sample may be filtered from the training data set if the core ratio is less than or equal to a set parameter. For example, the core threshold parameter may be set to 1, 0.9, 0.8, 0.7, 0.6, 0.5, etc. If the core ratio is less than the core threshold parameter, the sample is filtered from the training data. For example, if the core threshold is 4/6, the border sample 604 in FIG. 6A will be removed because its core ratio 3/6 is smaller than the core threshold while border sample 654 in FIG. 6B will not be filtered out because its core ratio is 5/6. The result of filtering based upon a core threshold are shown in FIGS. 7A-7C.

FIG. 7A illustrates a graph 700 of a training data set based upon various core ratio values in accordance with some examples. The graph 700 shows the training data with border samples filtered when the core ratio is set to zero. Accordingly, no border samples will be filtered.

FIG. 7B filters elements that have some core elements within the filtered element's vicinity. FIG. 7B illustrates a graph 702 of a filtered training data set where border samples with a core ratio equal to or less than 0.2 have been filtered. Area 712 has some border samples that have been filtered from the training data shown in the graph 700. FIG. 7C shows a graph 704 that has even more border samples filtered based upon setting the core ratio to 0.3. Area 714 has additional samples filtered compared to the training data illustrated in the graph 702. Higher core ratios are more aggressive filters. Even if the sample is closer to the core based on the presence of core elements of the same class within the frame, the sample may be removed.

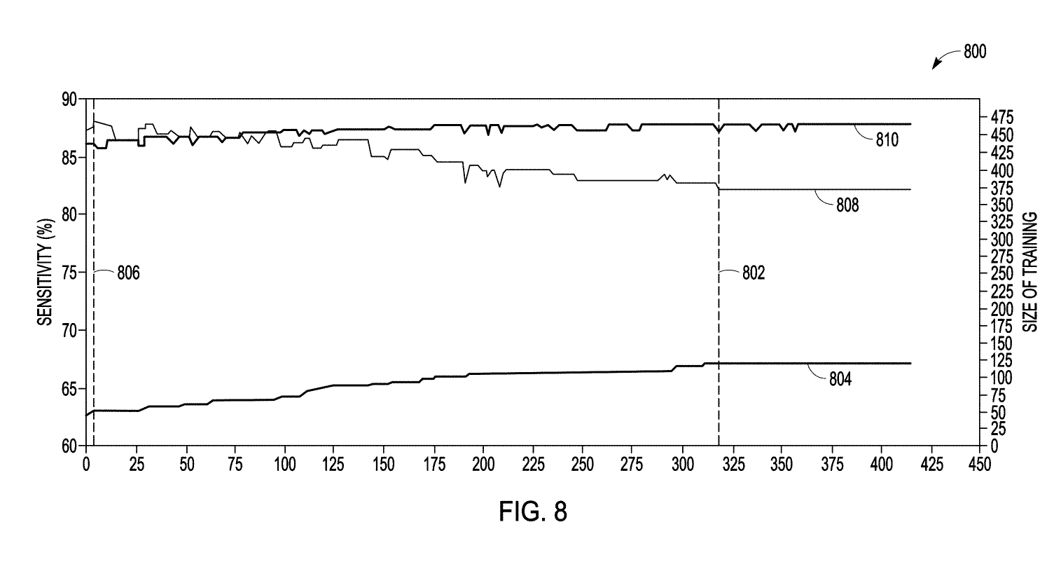

The results of using a filtered training data set may result in a less complex model that is either as accurate as or even more accurate than a model trained on the entire training data. FIG. 8 illustrates results 800 of various different models trained using different training data sets in accordance with some examples. The different models are based upon training a model using the entire training data set and also training multiple models using a filtered training data set. The average of the sensitivity of the classes of the models is plotted as line 808 and indicates the sensitivity of the model.

The base case model is shown with the dotted line 802. The base case model was trained using the entire training data. The base case achieved a sensitivity average of ˜83% implemented using around 120 RBFs. The amount of training data used to train a particular model is shown as line 810. The complexity of illustrated models may be gauged based upon the number of RBFs which is illustrated as line 804. After training models on various different filtered training data sets, the model with maximum sensitivity is shown by dotted line 806. The model that has the maximum sensitivity was trained with a reduced training set based upon filtering various samples as described herein. The model that achieved the highest sensitivity achieved ˜88% sensitivity and was implemented with only ˜50 RBFs. Thus, the maximum sensitivity model used less than half the number of RBFs compared to the base model. The maximum sensitivity model is both more accurate and less complex than the base model. Therefore, the model with ˜88% average sensitivity trained using a classified and filtered training set may use less memory and less computing resources to operate than the model trained with the original training set.

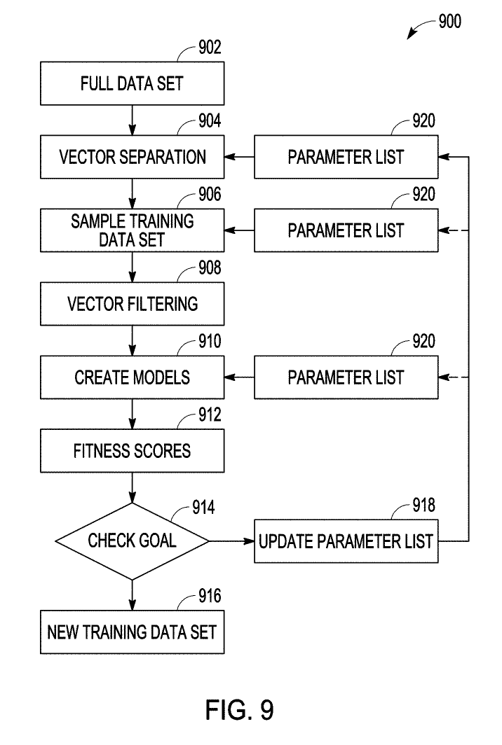

FIG. 9 is a flow diagram of a process 900 for filtering training data in accordance with some examples. The process flow 900 may be executed on a computing device. At operation 902, a data set is input. In an example, the data set is a full data set. In another example, the data set is a labeled data that may be broken up into a training data set and a validating data set. The data set includes a number of samples, each which may be a vector of properties, along with an indication of the correct class of the sample. The data set is used to create a training data set that is used to train a classifying model. The classifying model may be used to classify an element that was not part of the training data set.

At operation 904, the samples within the data set are classified as described above. For example, the samples may be classified as being one of a core, border, or noise sample. The sample classification, or vector separation, are done using various parameters. These parameters may include a frame size and the few and many parameters. In an example, only the samples within the training data set are used for vector separation. At operation 906, samples from the vector separated data set are sampled to create the training data set. At operation 908, certain samples are filtered from the training data as described above. For example, the noise and some or all of the border samples may be filtered from the training data. The filtered training data becomes the new training data set that is used to create models. At operation 910, models are created/trained using the new training data set. Accordingly, in the operation 910, the filtered samples are not used in training the models.

After the models are created, the models may be verified using a verification data set. The verification data set is similar to the training data set in that the verification data set includes various samples/vectors along with the proper classification for each of the samples/vectors. The verification data set, however, is not used to train the model. Rather, the verification data set is used to determine how accurate the model correctly classifies each of the samples in the verification data set. At operation 912, the verification data set may be used to create fitness scores. Fitness scores may include the sensitivity of the model, the accuracy of the model, and/or the number of neurons/RBFs within the model. At operation 914, the fitness scores may be used to determine if a model meets certain goals. For example, if the sensitivity of the model is above a predetermined threshold, the model may be deemed accurate enough. In another example, if the number of RBF of the model is below a predetermined threshold, the model may be deemed simple enough. In another example, the sensitivity and a complexity of the model may be compared to set parameters derived from an existing model. For example, a base model using the entire training data or a filtered training data set may be determined. A goal may be that the model has some number less neurons/RBFs compared to the base model. In this example, a trained model may meet the goals when the model is just as accurate or more accurate and is less complex compared to the base model. At operation 916, when the trained model meets the set goals, the training data set used to create the model is output. In addition, the model itself may be out. In another example, the model without the training data set is output.

At operation 918, no model met the set goals and the parameters used to generate the training data may be updated. The model creation process may be iterated through again using an updated parameter list. The parameters may be updated by changing one or more of the parameters. In an example using genetic algorithms, one or more parameters may be randomly updated by some amount. At operations 920, the updated parameters may then be fed back into the training data filtering process. The filtering process may then be reran until a trained model meets the set goals or a maximum number of iterations is reached. In some examples, the process goes through the maximum number of iterations and one or more of the best scoring models and training data are saved and output.

As described above, samples in a training data set that are classified based on other samples in the immediate neighborhood/vicinity of the sample followed by selectively filtering out certain types of samples has various advantages compared to using the entire training data set. Filtering out samples that add complexity without improving the quality of the model yields models with comparable quality that are less complex. This reduces the size of memory and computational resources needed to run the model. The reduced training data set also reduces the computational resources needed to learn the model because the “shape” of classes to be learned from the reduced training data set is simpler. In addition, there are fewer samples in the training data set to process. Further, the sample classification, or vector separation, algorithm operates on information in a small region, e.g., a frame, surrounding a sample. The computational cost to separate the training samples is, therefore, small and grows roughly linearly with the number of samples in the training data set. The additional overhead to separate training samples may even be smaller for machine learning algorithms that already calculate a matrix with distances between training samples, such as clustering algorithms.

Using the reduced training data set allows learning algorithms to take advantage of training data sets that are without noise or samples in a confusion/ambiguous region to reach better results faster. For example, the larger RBF centered on a data point that do not cover a sample of a different class calculated statistically may have a larger radius relative to using the entire training data set that includes samples that are noise or ambiguous. For an RBF trained with the full training data set to have a similar radius to the RBF trained on the filtered data set, the learning algorithm would have to dynamically try combination of samples or calculate an RBF that covers some samples of different classes. This makes the learning algorithm more complex.

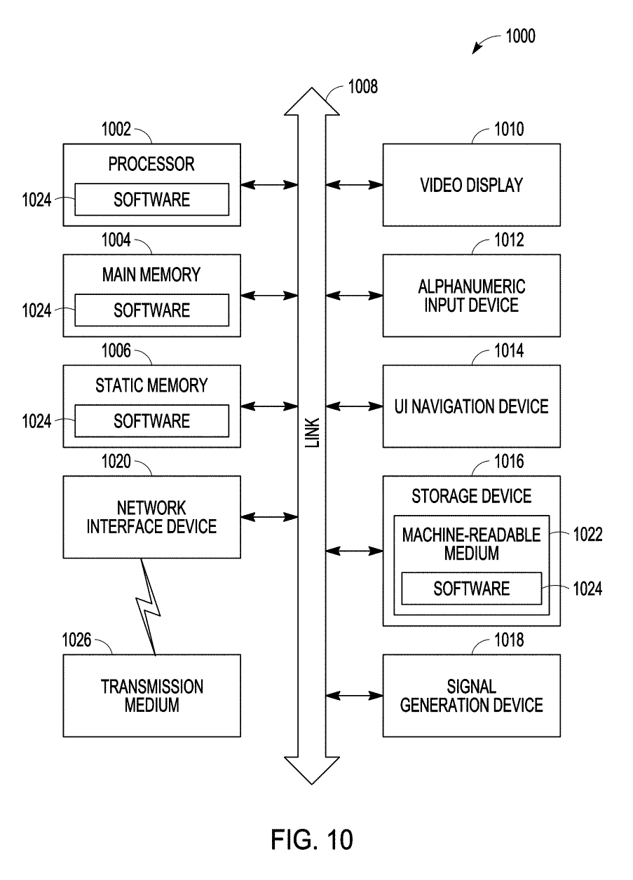

FIG. 10 is an example computing device that may be used in conjunction with the technologies described herein. In alternative embodiments, the computing device 1000 may operate as a standalone device or may be connected (e.g., networked) to other computing devices. In a networked deployment, the computing device 1000 may operate in the capacity of a server communication device, a client communication device, or both in server-client network environments. In an example, the computing device 1000 may act as a peer computing device in peer-to-peer (P2P) (or other distributed) network environment. The computing device 1000 may be a personal computer (PC), a tablet PC, a set top box (STB), a personal digital assistant (PDA), a mobile telephone, a smart phone, a web appliance, a network router, switch or bridge, or any computing device capable of executing instructions (sequential or otherwise) that specify actions to be taken by that computing device. Further, while only a single computing device is illustrated, the term “computing device” shall also be taken to include any collection of computing devices that individually or jointly execute a set (or multiple sets) of instructions to perform any one or more of the methodologies discussed herein, such as cloud computing, software as a service (SaaS), other computer cluster configurations.

Computing device 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The computing device 1000 may further include a display unit 1010, an input device 1012 (e.g., a keyboard), and a user interface (UI) navigation device 1014 (e.g., a mouse). In an example, the display unit 1010, input device 1012, and UI navigation device 1014 may be a touch screen display. In an example, the input device 1012 may include a touchscreen, a microphone, a camera (e.g., a panoramic or high-resolution camera), physical keyboard, trackball, or other input devices.

The computing device 1000 may additionally include a storage device (e.g., drive unit) 1016, a signal generation device 1018 (e.g., a speaker, a projection device, or any other type of information output device), a network interface device 1020, and one or more sensors 1021, such as a global positioning system (GPS) sensor, compass, accelerometer, motion detector, or other sensor. The computing device 1000 may include an input/output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.) via one or more input/output ports.

The storage device 1016 may include a computing device (or machine) readable medium 1022, on which is stored one or more sets of data structures or instructions 1024 (e.g., software) embodying or utilized by any one or more of the techniques or functions described herein. In an example, at least a portion of the software may include an operating system and/or one or more applications (or apps) implementing one or more of the functionalities described herein. The instructions 1024 may also reside, completely or at least partially, within the main memory 1004, within the static memory 1006, and/or within the hardware processor 1002 during execution thereof by the computing device 1000. In an example, one or any combination of the hardware processor 1002, the main memory 1004, the static memory 1006, or the storage device 1016 may constitute computing device (or machine) readable media.

While the computing device readable medium 1022 is illustrated as a single medium, a “computing device readable medium” or “machine-readable medium” may include a single medium or multiple media (e.g., a centralized or distributed database, and/or associated caches and servers) configured to store the one or more instructions 1024.

In an example, a computing device readable medium or machine-readable medium may include any medium that is capable of storing, encoding, or carrying instructions for execution by the computing device 1000 and that cause the computing device 1000 to perform any one or more of the techniques of the present disclosure, or that is capable of storing, encoding or carrying data structures used by or associated with such instructions. Non-limiting computing device readable medium examples may include solid-state memories, and optical and magnetic media. Specific examples of computing device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and optical media disks. In some examples, computing device readable media may include non-transitory computing device readable media. In some examples, computing device readable media may include computing device readable media that is not a transitory propagating signal.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.3 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1020 may include one or more physical jacks (e.g., Ethernet, coaxial, or phone jacks) or one or more antennas to connect to the communications network 1026. In an example, the network interface device 1020 may include one or more wireless modems, such as a Bluetooth modem, a Wi-Fi modem or one or more modems or transceivers operating under any of the communication standards mentioned herein. In an example, the network interface device 1020 may include a plurality of antennas to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques. In an example, a transmission medium may include any intangible medium that is capable of storing, encoding or carrying instructions for execution by the computing device 1000, and includes digital or analog communications signals or like communication media to facilitate communication of such software.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

### ADDITIONAL NOTES AND EXAMPLES

Example 1 is a system for reducing training set samples, the system comprising: processing circuitry to: separate a plurality of samples in a training data set into a plurality of classes using at least a few parameter and a many parameter and a number of samples within a vicinity of a sample, each of the plurality of samples comprising a vector of properties, and each of the plurality of samples belonging to one of a plurality of categories based upon the vector of properties and a classifier model; filter from the training data set a plurality of samples that are classified into a filtered class; create a new training set based upon the filtered training data set; create a new classifier model using the new training set, the new classifier model comprising a plurality of radial basis functions; and validate the new classifier model with a verification data set.

In Example 2, the subject matter of Example 1 optionally includes wherein the plurality of classes comprises a core class, a boundary class, and a noise class.

In Example 3, the subject matter of Example 2 optionally includes wherein to separate vectors, the processing circuitry is to determine, for each of the plurality of samples, a number of other samples in a vicinity of a sample.

In Example 4, the subject matter of Example 3 optionally includes wherein the vicinity is the same for each of the plurality of samples.

In Example 5, the subject matter of Example 4 optionally includes wherein to separate vectors, the processing circuitry is to: determine a first number of samples from the plurality of samples in the vicinity of the sample that have the same class as the sample; determine a second number of samples from the plurality of samples in the vicinity of the sample that have a different class as the sample; and classify the sample into the noise class when the first number is less than the few parameter and the second number is greater than the many parameter.

In Example 6, the subject matter of any one or more of Examples 4-5 optionally include wherein to separate vectors, the processing circuitry is to: determine a first number of samples from the plurality of samples in the vicinity of the sample that have the same class as the sample; determine a second number of samples from the plurality of samples in the vicinity of the sample that have a different class as the sample; and classify the sample into the core class when the first number is greater than the many parameter and the second number is less than the few parameter.

In Example 7, the subject matter of any one or more of Examples 4-6 optionally include wherein the plurality of classes further comprise an edge class.

In Example 8, the subject matter of Example 7 optionally includes wherein to separate vectors, the processing circuitry is to: determine a first number of samples from the plurality of samples in the vicinity of the sample that have the same class as the sample; determine a second number of samples from the plurality of samples in the vicinity of the sample that have a different class as the sample; and classify the sample into the edge class when the first number is less than the few parameter and the second number is less than the few parameter.

In Example 9, the subject matter of any one or more of Examples 4-8 optionally include wherein the plurality of classes further comprise an outlier noise class.

In Example 10, the subject matter of Example 9 optionally includes wherein to separate vectors, the processing circuitry is to: determine a first number of samples from the plurality of samples in the vicinity of the sample that have the same class as the sample; determine a second number of samples from the plurality of samples in the vicinity of the sample that have a different class as the sample; and classify the sample into the outlier noise class when the first number is zero and the second number is zero.

In Example 11, the subject matter of Example 10 optionally includes wherein the filtered classes comprise the noise class, the boundary class, and the outlier noise class.

In Example 12, the subject matter of any one or more of Examples 4-11 optionally include wherein the filtered classes comprise the noise class and the boundary class.

In Example 13, the subject matter of any one or more of Examples 1-12 optionally include wherein the processing circuitry is to: modify the few parameter and the many parameter; and create an additional classifier model based upon re-separating the plurality of samples and re-filtering the training data.

In Example 14, the subject matter of Example 13 optionally includes wherein the new classifier model has a sensitivity value greater than a sensitivity value of a base classifier model using the entire training data set, and wherein a number of radial basis functions within the new classifier model is less than the a number of radial basis functions in the base classifier model.

Example 15 is a method for reducing training set samples, the method comprising: separating a plurality of samples in a training data set into a plurality of classes using at least a few parameter and a many parameter and a number of samples within a vicinity of a sample, each of the plurality of samples comprising a vector of properties, and each of the plurality of samples belonging to one of a plurality of categories based upon the vector of properties and a classifier model; filtering from the training data set a plurality of samples that are classified into a filtered class; creating a new training set based upon the filtered training data set; creating a new classifier model using the new training set, the new classifier model comprising a plurality of radial basis functions; and validating the new classifier model with a verification data set.

In Example 16, the subject matter of Example 15 optionally includes wherein the plurality of classes comprises a core class, a boundary class, and a noise class.

In Example 17, the subject matter of Example 16 optionally includes wherein the separating vectors comprises determining, for each of the plurality of samples, a number of other samples in a vicinity of a sample.

In Example 18, the subject matter of Example 17 optionally includes wherein the vicinity is the same for each of the plurality of samples.

In Example 19, the subject matter of Example 18 optionally includes wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the noise class when the first number is less than the few parameter and the second number is greater than the many parameter.

In Example 20, the subject matter of any one or more of Examples 18-19 optionally include wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the core class when the first number is greater than the many parameter and the second number is less than the few parameter.

In Example 21, the subject matter of any one or more of Examples 18-20 optionally include wherein the plurality of classes further comprise an edge class.

In Example 22, the subject matter of Example 21 optionally includes wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the edge class when the first number is less than the few parameter and the second number is less than the few parameter.

In Example 23, the subject matter of any one or more of Examples 18-22 optionally include wherein the plurality of classes further comprise an outlier noise class.

In Example 24, the subject matter of Example 23 optionally includes wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the outlier noise class when the first number is zero and the second number is zero.

In Example 25, the subject matter of Example 24 optionally includes wherein the filtered classes comprise the noise class, the boundary class, and the outlier noise class.

In Example 26, the subject matter of any one or more of Examples 18-25 optionally include wherein the filtered classes comprise the noise class and the boundary class.

In Example 27, the subject matter of any one or more of Examples 15-26 optionally include modifying the few parameter and the many parameter; and creating an additional classifier model based upon re-separating the plurality of samples and re-filtering the training data.

In Example 28, the subject matter of Example 27 optionally includes wherein the new classifier model has a sensitivity value greater than a sensitivity value of a base classifier model using the entire training data set, and wherein a number of radial basis functions within the new classifier model is less than the a number of radial basis functions in the base classifier model.

Example 29 is at least one computer-readable medium, including instructions, which when executed by a machine, cause the machine to perform operations: separating a plurality of samples in a training data set into a plurality of classes using at least a few parameter and a many parameter and a number of samples within a vicinity of a sample, each of the plurality of samples comprising a vector of properties, and each of the plurality of samples belonging to one of a plurality of categories based upon the vector of properties and a classifier model; filtering from the training data set a plurality of samples that are classified into a filtered class; creating a new training set based upon the filtered training data set; creating a new classifier model using the new training set, the new classifier model comprising a plurality of radial basis functions; and validating the new classifier model with a verification data set.

In Example 30, the subject matter of Example 29 optionally includes wherein the plurality of classes comprises a core class, a boundary class, and a noise class.

In Example 31, the subject matter of Example 30 optionally includes wherein the separating vectors comprises determining, for each of the plurality of samples, a number of other samples in a vicinity of a sample.

In Example 32, the subject matter of Example 31 optionally includes wherein the vicinity is the same for each of the plurality of samples.

In Example 33, the subject matter of Example 32 optionally includes wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the noise class when the first number is less than the few parameter and the second number is greater than the many parameter.

In Example 34, the subject matter of any one or more of Examples 32-33 optionally include wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the core class when the first number is greater than the many parameter and the second number is less than the few parameter.

In Example 35, the subject matter of any one or more of Examples 32-34 optionally include wherein the plurality of classes further comprise an edge class.

In Example 36, the subject matter of Example 35 optionally includes wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the edge class when the first number is less than the few parameter and the second number is less than the few parameter.

In Example 37, the subject matter of any one or more of Examples 32-36 optionally include wherein the plurality of classes further comprise an outlier noise class.

In Example 38, the subject matter of Example 37 optionally includes wherein the separating vectors comprises: determining a first number of samples from the plurality of samples in the vicinity of the sample that have the same class as the sample; determining a second number of samples from the plurality of samples in the vicinity of the sample that have a different class as the sample; and classifying the sample into the outlier noise class when the first number is zero and the second number is zero.

In Example 39, the subject matter of Example 38 optionally includes wherein the filtered classes comprise the noise class, the boundary class, and the outlier noise class.

In Example 40, the subject matter of any one or more of Examples 32-39 optionally include wherein the filtered classes comprise the noise class and the boundary class.

In Example 41, the subject matter of any one or more of Examples 29-40 optionally include modifying the few parameter and the many parameter, and creating an additional classifier model based upon re-separating the plurality of samples and re-filtering the training data.

In Example 42, the subject matter of Example 41 optionally includes wherein the new classifier model has a sensitivity value greater than a sensitivity value of a base classifier model using the entire training data set, and wherein a number of radial basis functions within the new classifier model is less than the a number of radial basis functions in the base classifier model.

Example 43 is an apparatus for compressing data, the apparatus comprising: means for separating a plurality of samples in a training data set into a plurality of classes using at least a few parameter and a many parameter and a number of samples within a vicinity of a sample, each of the plurality of samples comprising a vector of properties, and each of the plurality of samples belonging to one of a plurality of categories based upon the vector of properties and a classifier model; means for filtering from the training data set a plurality of samples that are classified into a filtered class; means for creating a new training set based upon the filtered training data set; means for creating a new classifier model using the new training set, the new classifier model comprising a plurality of radial basis functions; and means for validating the new classifier model with a verification data set.

In Example 44, the subject matter of any one or more of Examples 42-43 optionally include wherein the plurality of classes comprises a core class, a boundary class, and a noise class.

In Example 45, the subject matter of Example 44 optionally includes wherein the separating vectors comprises means for determining, for each of the plurality of samples, a number of other samples in a vicinity of a sample.

In Example 46, the subject matter of any one or more of Examples 43-45 optionally include wherein the vicinity is the same for each of the plurality of samples.

In Example 47, the subject matter of Example 46 optionally includes wherein the separating vectors comprises: means for determining a first number of samples from the plurality of samples in the vicinity of the sample that have the same class as the sample; means for determining a second number of samples from the plurality of samples in the vicinity of the sample that have a different class as the sample; and means for classifying the sample into the noise class when the first number is less than the few parameter and the second number is greater than the many parameter.

In Example 48, the subject matter of any one or more of Examples 46-47 optionally include wherein the separating vectors comprises: means for determining a first number of samples from the plurality of samples in the vicinity of the sample that have the same class as the sample; means for determining a second number of samples from the plurality of samples in the vicinity of the sample that have a different class as the sample; and means for classifying the sample into the core class when the first number is greater than the many parameter and the second number is less than the few parameter.

In Example 49, the subject matter of any one or more of Examples 46-48 optionally include wherein the plurality of classes further comprise an edge class.

In Example 50, the subject matter of Example 49 optionally includes wherein the separating vectors comprises: means for determining a first number of samples from the plurality of samples in the vicinity of the sample that have the same class as the sample; means for determining a second number of samples from the plurality of samples in the vicinity of the sample that have a different class as the sample; and means for classifying the sample into the edge class when the first number is less than the few parameter and the second number is less than the few parameter.

In Example 51, the subject matter of any one or more of Examples 46-50 optionally include wherein the plurality of classes further comprise an outlier noise class.

In Example 52, the subject matter of Example 51 optionally includes wherein the separating vectors comprises: means for determining a first number of samples from the plurality of samples in the vicinity of the sample that have the same class as the sample; means for determining a second number of samples from the plurality of samples in the vicinity of the sample that have a different class as the sample; and means for classifying the sample into the outlier noise class when the first number is zero and the second number is zero.

In Example 53, the subject matter of Example 52 optionally includes wherein the filtered classes comprise the noise class, the boundary class, and the outlier noise class.

In Example 54, the subject matter of any one or more of Examples 46-53 optionally include wherein the filtered classes comprise the noise class and the boundary class.

In Example 55, the subject matter of any one or more of Examples 43-54 optionally include means for modifying the few parameter and the many parameter; and means for creating an additional classifier model based upon re-separating the plurality of samples and re-filtering the training data.

In Example 56, the subject matter of Example 55 optionally includes wherein the new classifier model has a sensitivity value greater than a sensitivity value of a base classifier model using the entire training data set, and wherein a number of radial basis functions within the new classifier model is less than the a number of radial basis functions in the base classifier model.

Example 57 is at least one machine-readable medium including instructions, which when executed by a machine, cause the machine to perform operations of any of the methods of Examples 15-28.

Example 58 is an apparatus comprising means for performing any of the methods of Examples 15-28.

Example 59 is at least one machine-readable medium including instructions, which when executed by a machine, cause the machine to perform operations of any of the operations of Examples 1-56.

Example 60 is an apparatus comprising means for performing any of the operations of Examples 1-56.

Example 61 is a system to perform the operations of any of the Examples 1-56.

Example 62 is a method to perform the operations of any of Examples 1-56.

The above description is intended to be illustrative, and not restrictive. For example, the above-described examples (or one or more aspects thereof) may be used in combination with others. Other embodiments may be used, such as by one of ordinary skill in the art upon reviewing the above description. Further, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for reducing training set samples, the system comprising:
processing circuitry to:
separate a plurality of samples in a training data set into a plurality of classes using at least a few parameter and a many parameter and a number of samples within a vicinity of a sample, each of the plurality of samples comprising a vector of properties, and each of the plurality of samples belonging to one of a plurality of categories based upon the vector of properties and a classifier model;
filter from the training data set a plurality of samples that are classified into a filtered class;
create a new training set based upon the filtered training data set;
create a new classifier model using the new training set, the new classifier model comprising a plurality of radial basis functions; and
validate the new classifier model with a verification data set.

2. The system of claim 1, wherein the plurality of classes comprises a core class, a boundary class, and a noise class.

3. The system of claim 2, wherein to separate vectors, the processing circuitry is to determine, for each of the plurality of samples, a number of other samples in a vicinity of a sample.

4. The system of claim 3, wherein the vicinity is the same for each of the plurality of samples.

5. The system of claim 4, wherein to separate vectors, the processing circuitry is to:
determine a first number of samples from the plurality of samples in the vicinity of the sample that have the same class as the sample;
determine a second number of samples from the plurality of samples in the vicinity of the sample that have a different class as the sample; and
classify the sample into the noise class when the first number is less than the few parameter and the second number is greater than the many parameter.

6. The system of claim 4, wherein to separate vectors, the processing circuitry is to:
determine a first number of samples from the plurality of samples in the vicinity of the sample that have the same class as the sample;
determine a second number of samples from the plurality of samples in the vicinity of the sample that have a different class as the sample; and
classify the sample into the core class when the first number is greater than the many parameter and the second number is less than the few parameter.

7. The system of claim 4, wherein the plurality of classes further comprise an edge class.

8. The system of claim 7, wherein to separate vectors, the processing circuitry is to:
determine a first number of samples from the plurality of samples in the vicinity of the sample that have the same class as the sample;
determine a second number of samples from the plurality of samples in the vicinity of the sample that have a different class as the sample; and
classify the sample into the edge class when the first number is less than the few parameter and the second number is less than the few parameter.

9. The system of claim 4, wherein the plurality of classes further comprise an outlier noise class.

10. The system of claim 9, wherein to separate vectors, the processing circuitry is to:
determine a first number of samples from the plurality of samples in the vicinity of the sample that have the same class as the sample;
determine a second number of samples from the plurality of samples in the vicinity of the sample that have a different class as the sample; and
classify the sample into the outlier noise class when the first number is zero and the second number is zero.

11. The system of claim 10, wherein the filtered classes comprise the noise class, the boundary class, and the outlier noise class.

12. The system of claim 4, wherein the filtered classes comprise the noise class and the boundary class.

13. The system of claim 1, wherein the processing circuitry is to:
modify the few parameter and the many parameter; and
create an additional classifier model based upon re-separating the plurality of samples and re-filtering the training data.

14. The system of claim 13, wherein the new classifier model has a sensitivity value greater than a sensitivity value of a base classifier model using the entire training data set, and wherein a number of radial basis functions within the new classifier model is less than the a number of radial basis functions in the base classifier model.

15. A method for reducing training set samples, the method comprising:
separating a plurality of samples in a training data set into a plurality of classes using at least a few parameter and a many parameter and a number of samples within a vicinity of a sample, each of the plurality of samples comprising a vector of properties, and each of the plurality of samples belonging to one of a plurality of categories based upon the vector of properties and a classifier model;
filtering from the training data set a plurality of samples that are classified into a filtered class;
creating a new training set based upon the filtered training data set;
creating a new classifier model using the new training set, the new classifier model comprising a plurality of radial basis functions; and
validating the new classifier model with a verification data set.

16. The method of claim 15, wherein the plurality of classes comprises a core class, a boundary class, and a noise class.

17. The method of claim 16, wherein the separating vectors comprises determining, for each of the plurality of samples, a number of other samples in a vicinity of a sample.

18. The method of claim 17, wherein the vicinity is the same for each of the plurality of samples.

19. The method of claim 18, wherein the separating vectors comprises:
determining a first number of samples from the plurality of samples in the vicinity of the sample that have the same class as the sample;
determining a second number of samples from the plurality of samples in the vicinity of the sample that have a different class as the sample; and
classifying the sample into the noise class when the first number is less than the few parameter and the second number is greater than the many parameter.

20. The method of claim 18, wherein the separating vectors comprises:
determining a first number of samples from the plurality of samples in the vicinity of the sample that have the same class as the sample;
determining a second number of samples from the plurality of samples in the vicinity of the sample that have a different class as the sample; and
classifying the sample into the core class when the first number is greater than the many parameter and the second number is less than the few parameter.

21. At least one computer-readable medium, including instructions, which when executed by a machine, cause the machine to perform operations:
separating a plurality of samples in a training data set into a plurality of classes using at least a few parameter and a many parameter and a number of samples within a vicinity of a sample, each of the plurality of samples comprising a vector of properties, and each of the plurality of samples belonging to one of a plurality of categories based upon the vector of properties and a classifier model;
filtering from the training data set a plurality of samples that are classified into a filtered class;
creating a new training set based upon the filtered training data set;
creating a new classifier model using the new training set, the new classifier model comprising a plurality of radial basis functions; and
validating the new classifier model with a verification data set.

22. The at least one computer-readable medium of claim 21, wherein the plurality of classes comprises a core class, a boundary class, and a noise class.

23. The at least one computer-readable medium of claim 22, wherein the separating vectors comprises determining, for each of the plurality of samples, a number of other samples in a vicinity of a sample.

24. The at least one computer-readable medium of claim 23, wherein the vicinity is the same for each of the plurality of samples.

25. The at least one computer-readable medium of claim 24, wherein the separating vectors comprises:
determining a first number of samples from the plurality of samples in the vicinity of the sample that have the same class as the sample;
determining a second number of samples from the plurality of samples in the vicinity of the sample that have a different class as the sample; and
classifying the sample into the noise class when the first number is less than the few parameter and the second number is greater than the many parameter.
